(19) United States
(12) Patent Application Publication
(10) Pub. No.: US 2003/0050938 A1
(43) Pub. Date: Mar. 13, 2003

(54) System for storing and updating document data and method thereof

(76) Inventors: Pin Peng, Taipei (TW); Shyhjir Ferng, Taipei (TW); Chun-Wei Kao, Taipei (TW); Khoo Bee Yeong, Taipei (TW); Chia-Ming Chung, Taipei (TW); Yuan-Jung Chang, Taipei (TW)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 10/227,702

(22) Filed: Aug. 26, 2002

(30) Foreign Application Priority Data
Sep. 7, 2001 (CN) 90122195

(51) Int. Cl. G06F 12/00

(52) U.S. Cl. 707/200

(57) ABSTRACT

The present invention discloses a method and a system for storing and updating a document data. The method includes steps of providing a data storage device for storing the initial document data, providing a remote loading device for receiving the initial document data, wirelessly transmitting the initial document data into the remote loading device, updating the initial document data with an updated document data via the remote loading device, and wirelessly transmitting the updated document data to the data storage device to be stored therein.

### FIELD OF THE INVENTION

The present invention is related to a system for storing and updating a document data and a method thereof, and more particularly to a system for storing and updating a document data via a wireless transmitting device and a method thereof.

### BACKGROUND OF THE INVENTION

Most of the present commercial instruments (industrial instruments, medical instruments, household appliances, computer instruments, transportation vehicles and crafts, Personal Digital Assistant (PDA), communication apparatus, play stations, cameras, photo instruments, peripheral instruments and so on) provide some documents of manuals or instructions leaflets, tapes, videos, discs, or compact discs for instruction. The user has to keep the documents or the instructing media very well. However, the documents and the instructing media are usually damaged or lost due to man-made factors or time factors. Therefore, the user can't operate the instruments by means of referring the documents or the instructing media of themselves. Furthermore, when the instruments need to be reset, updated or operated in an advanced mode, the user has to find out the documents and the instructing media of themselves, thereby the instruments being operated, reset and updated successfully. That is quite inconvenient.

If a user wants to operate an instrument swimmingly, the user has to spend quite time to learn and research the instrument. It is easy for the user to learn and research the instrument by means of operating according to the documents and the instructing media. However if the documents and the instructing media of the instrument have been damaged or lost, the user has to learn and research the instrument by means of try-and-error continuously thereby the instrument being operated correctly. Moreover, the instrument may be too complex to be operated without the documents and the instructing media.

Hence, the present invention attempts to improve the prior art and provides a system for storing and updating a document data via a wireless transmitting device and a method thereof. Meanwhile the documents and the instructing media are stored in a data storage, and the user could load, retrieve and update the documents and the instructing media the wireless transmitting device without vexation of missing the documents and the instructing media.

### SUMMARY OF THE INVENTION

It is one object of the present invention to provide a method for storing and updating a document data via a wireless transmitting device without vexation of missing the document data.

According to the present invention, the method for storing and updating an initial document data, includes steps of (a) providing a data storing device for storing the initial document data, (b) providing a remote loading device for receiving the initial document data, (c) wirelessly transmitting the initial document data into the remote loading device, (d) updating the initial document data with an updated document data via the remote loading device, and (e) wirelessly transmitting the updated document data to the data storage device to be stored therein.

Certainly, the initial document data and the updated document data can be transmitted via a data-transmitting unit.

Certainly, the data-transmitting unit can be a wireless module.

Certainly, the wireless module can be a wireless transmitting device.

Certainly, the wireless transmitting device can be one selected from a group consisting of an infrared-ray transmitting device, Bluetooth, 802.11X, Home RF, HIPER Lan, an optical transmitting device and a radio transmitting device.

Certainly, the initial document data can be the updated document data.

Preferably, the step (b) further includes a step of (b1) making a loading request of the initial document data via the remote loading device.

Preferably, the step (b) further includes a step of (b2) making a transmitting request of the initial document data via the data storage device.

Preferably, the step (d) further includes a step of (d1) temporarily storing one of the initial document data and the updated document data in a data storage unit of the remote loading device.

Preferably, the step (d) further includes a step of (d2) displaying one of the initial document data and the updated document data via a data-displaying unit.

Preferably, the step (d) further includes a step of (d3) transmitting one of the initial document data and the updated document data to one selected from a group consisting of a computer, a peripheral device, a PDA, a Web TV, a STB, and a play station via a data-transmitting unit.

Certainly, the data-transmitting unit can be a wireless transmitting device.

Preferably, the step (c) further includes a preceding step of compressing/uncompressing the initial document data via a data-transforming unit.

Preferably, the step (c) further includes a preceding step of coding/decoding the initial document data via a data-transforming unit.

Preferably, the step (e) further includes a preceding step of compressing/uncompressing the updated document data via a data-transforming unit.

Preferably, the step (e) further includes a preceding step of coding/decoding the updated document data via a data-transforming unit.

Certainly, the document data can be one selected from a group consisting of a text file, a picture file, an audio file, a video file, and an image file.

It is one object of the present invention to provide a method for storing and updating a document data via a wireless transmitting device without vexation of missing the document data.

According to the present invention, the system for storing and updating an initial document data, includes a data storage device having a storage unit for storing the initial document data, a remote loading device for receiving and updating the initial document data with an updated document data, and a wireless module for transmitting the document data and the updated document data between the data storage and the remote loading device.

Certainly, the wireless module can be a wireless transmitting device.

Certainly, the wireless transmitting device can be one selected from a group consisting of an infrared-ray transmitting device, Bluetooth, 802.11X, Home RF, HIPER Lan, an optical transmitting device and a radio transmitting device.

Certainly, the storage unit can be one selected from a group consisting of an EEPROM, a flash memory, a disk, a hard disk, a CD/VCD/DVD, a CF card, a SM card, a secure digital, a multi media card, a memory stick, a memory stick duo, a mask ROM, and a nonvolatile memory media.

Preferably, the data storage device further includes a data-transmitting unit for transmitting the initial document data stored in the storage unit and receiving the updated document data transmitted from the remote loading device, a data-compressing unit for compressing the initial document data and uncompressing the updated document data, and a central processing unit for controlling an operating flow of the data storage unit, the data-compressing unit and the data-transmitting unit.

Preferably, the data storage device further includes a data-transmitting unit for transmitting the initial document data stored in the storage unit and receiving the updated document data transmitted from the remote loading device, a data-coding unit for coding the initial document data and decoding the updated document data, and a central processing unit for controlling an operating flow of the data storage unit, the data-coding unit and the data-transmitting unit.

Preferably, the remote loading device further includes a temporary storage unit for temporarily storing one of the initial document data and the updated document data therein.

Certainly, the temporary storage can be one selected from a group consisting of an EEPROM, a flash memory, a disk, a hard disk, a CD/VCD/DVD, a CF card, a SM card, a secure digital, a multi media card, a memory stick, a memory stick duo, a mask ROM, and a nonvolatile memory media.

Preferably, the remote loading device further includes a data-transmitting unit for receiving the initial document data transmitted from the data storage device and transmitting the updated document data to the data storage device, a data-compressing unit for compressing the updated document data and uncompressing the initial document data, and a central processing unit for controlling an operating flow of the temporary storage unit, the data-compressing unit and the data-transmitting unit.

Preferably, the remote loading device further includes a data-transmitting unit for receiving the initial document data transmitted from the data storage device and transmitting the updated document data to the data storage device, a data-coding unit for coding the updated document data and decoding the initial document data, and a central processing unit for controlling an operating flow of the temporary storage unit, the data-coding unit and the data-transmitting unit.

Preferably, the remote loading device further includes a data-displaying unit for displaying one of the initial document data the updated document data.

Certainly, the initial document data and the updated document data can be transmitted to one selected from a group consisting of a computer, a peripheral device, a PDA, a Web TV, a STB, and a play station via the remote loading device.

Certainly, the initial document data can be one selected from a group consisting of a text file, a picture file, an audio file, a video file, and an image file.

Preferably, the remote loading device loads the initial document data by means of making a loading request.

Preferably, the data storage device transmits the initial document data by means of making a transmitting request.

According to the present invention, the system for storing and updating an initial document data, includes a data storage device having a storage unit for storing the initial document data and a first wireless transceiver for transmitting the initial document data, and a remote loading device having a processing unit for updating the document data with an updated document data and a remote wireless transceiver for receiving the initial document data and transmitting the updated document data to the data storage device.

Now the foregoing and other features and advantages of the present invention will be more clearly understood through the following descriptions with reference to the drawings, wherein:

### BRIEF DESCRIPTION OF THE DRAWINGS

FIG. 1 illustrates a structural drawing of a system for storing and updating a document data according to the present invention;

FIGS. 2(a)-2(b) illustrate a data transmitted between the data storage device and the remote loading device according to the present invention;

FIG. 3 illustrates a flow chart of the method for storing and updating a document data according to the present invention; and

FIG. 4 illustrates a flow chart of updating a document data stored in the data storage device according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

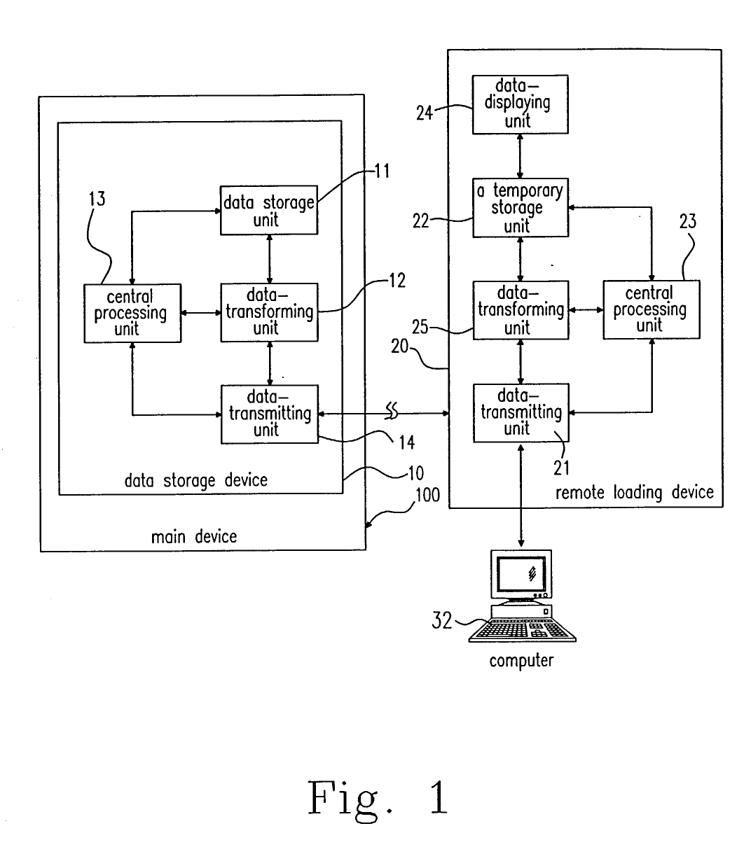

Please referring to FIG. 1, it illustrates a structural drawing of a system for storing and updating a document data according to the present invention. The present invention provides a system for storing, loading and managing a data document of an instrument. The system includes a main device 100 having a data storage device 10 for storing the initial document data of the main device 100, a remote loading device 20 for receiving the initial document data of the main device 100. Meanwhile the main device could be any general commercial instrument, just like industrial instruments, medical instruments, household appliances, computer instruments, transportation vehicles and crafts, Personal Digital Assistant (PDA), communication apparatus, play stations, cameras, photo instruments, peripheral instruments and so on. Furthermore, the data storage device 10 includes a data storage unit 11, a data-transmitting unit 14, a data-transforming unit 12, and a central processing unit 13. The remote loading device 20 includes a data-transmitting unit 21, a temporary storage unit 22, a central processing unit 23, a data-displaying unit 24, and a data-transforming unit 25.

According to the present invention, the data storage device 10 has the central processing unit 13 for controlling an operating flow of the storage unit 11, the data-transforming unit 12 and the data-transmitting unit 14, and the data storage unit 11 for storing the document data of the main device 100. The document data are introduction/manual/instruction data of a setup/operation/motion unit attached to the main device 100. Meanwhile the types of the document data could be (1) a writing form, just like a manual, a table, instructions and so on, (2) an analog form, just like a tape, a video and so on, or (3) a digital form, just like a disc, a CD, a VCD, a DVD and so on. The data storage unit 11 is a nonvolatile memory including an EEPROM, a flash memory, a disk, a hard disk, a CD/VCD/DVD, a CF card, a SM card, a secure digital, a multi media card, a memory stick, a memory stick duo, a mask ROM, and a nonvolatile memory media.

According to the present invention, the data storage device 10 transmits the initial document data stored in the data storage unit 11 to the remote loading device 20 or receiving the updated document data transmitted from the remote loading device 20 via the data-transmitting unit 14. The data storage device 10 has the data-transforming unit 12 to transform the document data for increasing the security of data, reducing occupation of the storage space or decreasing the transmitting time. Meanwhile the data-transforming unit 12 could be a data-compressing unit for compressing the initial document data and uncompressing the updated document data, or a data-coding unit for coding the initial document data and decoding the updated document data.

With respect to the remote loading device 20, it has the central processing unit 23 for controlling an operating flow of the temporary storage unit 22, the data-displaying unit 24, the data-transforming unit 25 and the data-transmitting unit 21. The remote loading device 20 receives the initial document data transmitted from the data storage device 10 and transmits the updated document data of the remote loading device 20 to the data storage device 10 via the data-transmitting unit 21. Certainly, the document data of the remote loading device 20 could be transformed via the data-transforming unit 25 for increasing the security of data, reducing occupation of the storage space or decreasing the transmitting time. Meanwhile the data-transforming unit 25 could be a data-compressing unit for compressing the updated document data and uncompressing the initial document data, or a data-coding unit for coding the updated document data and decoding the initial document data. Furthermore, the remote loading device 20 has the data-displaying unit for displaying the document data via a form selected from a group consisting of a text file, a picture file, an audio file, a video file, and an image file. Moreover the remote loading device 20 has the temporary storage unit 22 for temporarily storing the document data therein, wherein the document data could be transmitted to one selected from a group consisting of a computer 32, a peripheral device, a PDA, a Web TV, a STB, and a play station via the data-transmitting unit 21.

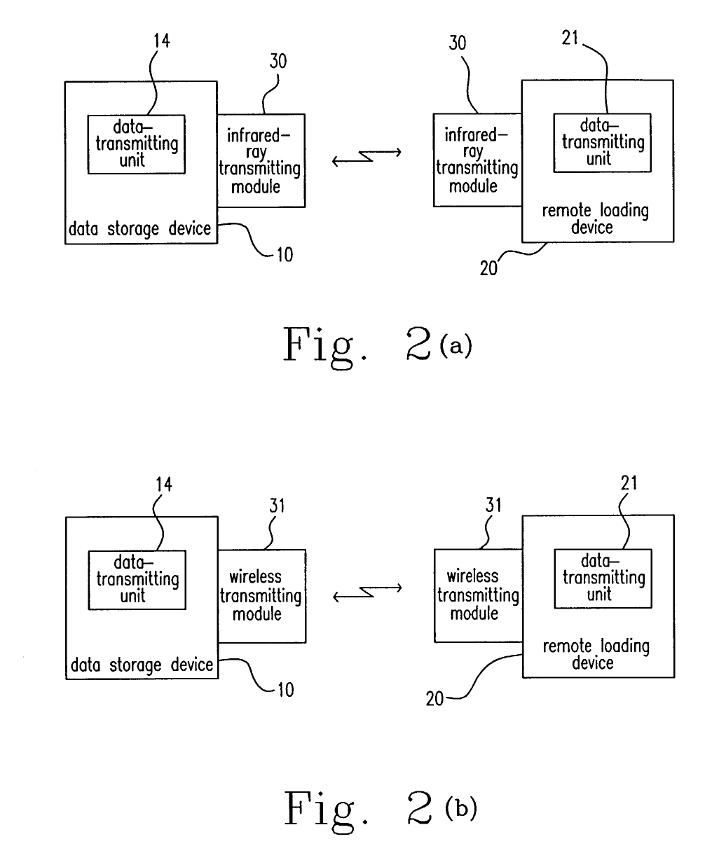

FIGS. 2(a)-2(b) illustrate a data transmitted between the data storage device and the remote loading device according to the present invention. The document data of the present invention are transmitted via the data-transmitting unit 14 of the data storage device 10 and the data-transmitting unit 21 of the remote loading device 20, wherein the data-transmitting units 14 and 21 could be wireless transmitting devices. Meanwhile, FIG. 2a illustrates the document data transmitted via an infrared-ray module 30 between the data storage device 10 and the remote loading device 20 according to the first preferred embodiment of the present invention. Moreover, FIG. 2b illustrates the document data transmitted via a wireless transmitting module 31 between the data storage device 10 and the remote loading device 20 according to the second preferred embodiment of the present invention. Certainly, the infrared-ray module 30/wireless transmitting module 31 could be one selected from a group consisting of an infrared-ray transmitting device, Bluetooth, 802.11X, Home RF, HIPER Lan, an optical transmitting device and a radio transmitting device.

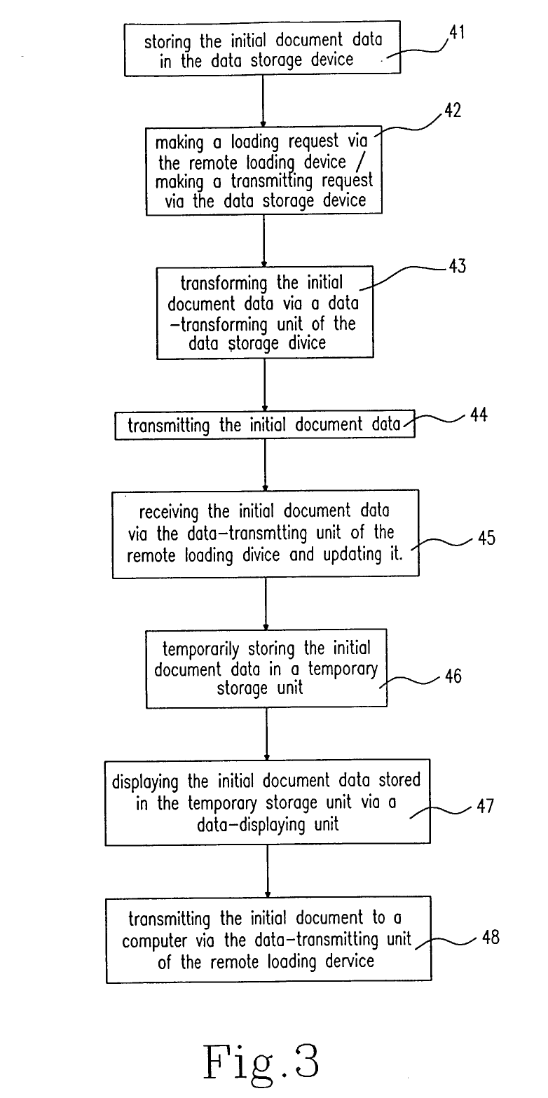

Referring to FIG. 3, it illustrates a flow chart of the method for storing, retrieving and updating a document data according to the present invention. The method includes steps of:

(a) providing a data storage device 10 for storing an initial document data of the main device 100 (step 41),

(b) making a loading request of the initial document data via the remote loading device 20 or making a transmitting request of the initial document data via the data storage device 10 (step 42),

(c) transforming the initial document data by means of compressing/uncompressing or coding/decoding via a data-transforming unit 12 of the data storage 10 (step 43),

(d) transmitting the initial document data through the data storage device 10 (step 44),

(e) wirelessly transmitting the initial document data into the remote loading device 20 via a data-transmitting unit 21 of the remote loading device 20 and updating the initial document data with an updated document data via the remote loading device 20 (step 45),

(f) temporarily storing one of the initial document data and the updated document data in a temporary data storage unit 22 of the remote loading device 20 (step 46),

(g) displaying one of the initial document data and the updated document data via a data-displaying unit 24 of the remote loading device 20 (step 47), and

(h) transmitting one of the initial document data and the updated document data to one selected from a group consisting of a computer 32, a peripheral device, a PDA, a Web TV, a STB, and a play station via a data-transmitting unit 21 of the remote loading device 20 (step 48).

Meanwhile the initial document data could be the updated document data. When the user doesn't want to reset or upgraded the initial document data, the updated document data, the same as the initial document data, is wirelessly transmitted to the data storage device 10 to be stored therein.

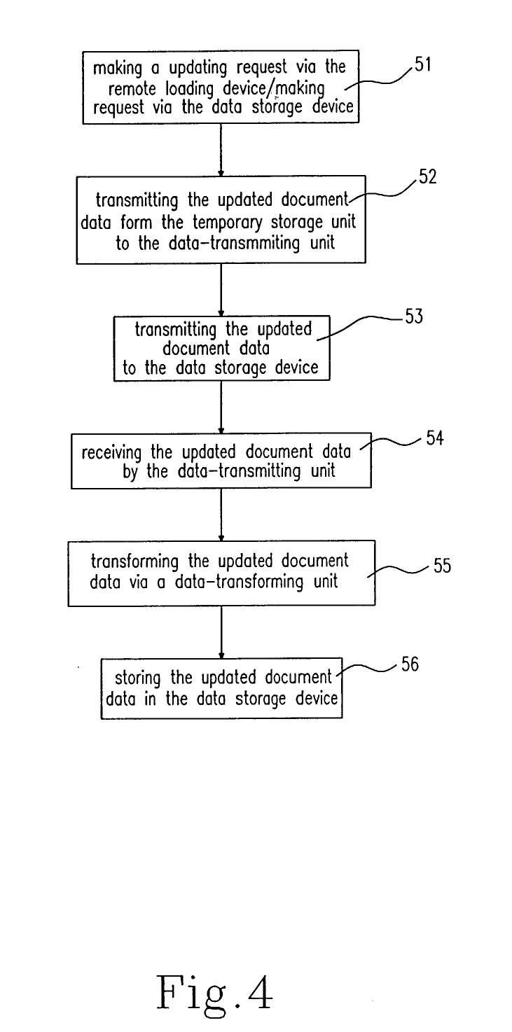

Please refer to FIG. 4. It illustrates a flow chart of updating a document data stored in the data storage device according to the present invention. When the main device 100 has to be reset or upgraded, the user could update the document data of the main device 100 be means of updating the initial document data with an updated document data via the remote loading device 20. The updating process includes steps of:

(a′) making a loading request of the initial document data via the remote loading device 20 or making a transmitting request of the initial document data via the data storage device 10 (step 51),

(b′) transmitting the updated document data from the temporary data storage unit 22 of the remote loading device 20 to the data-transmitting unit 21 of the remote loading device 20 (step 52),

(c′) wirelessly transmitting the updated document data to the data storage device 10 via the data-transmitting unit 21 of the remote loading device 20 (step 53),

(d′) wirelessly receiving the updated document data by the data-transmitting unit 14 of the data storage device 10 (step 54),

(e′) transforming the updated document data by means of compressing/uncompressing or coding/decoding via a data-transforming unit 12 of the data storage device 10 (step 55), and

(f′) storing the updated document data in the data storage unit 11 of the data storage device 10 (step 56).

Accordingly, the present invention attempts to improve the prior art and provides a system for storing and updating a document data via a wireless transmitting device. Meanwhile the document data are stored in a data storage device, and the user could load and update the document data via the wireless transmitting device without vexation of missing the document data.

Although the present invention has been described and illustrated in detail, it is to be clearly understood that the same is by the way of illustration and example only and is not to be taken by way of limitation, the spirit and scope of the present invention being limited only by the terms of the appended claims.

What is claimed is:

1. A method for storing and updating an initial document data, comprising steps of:
(a) providing a data storage device for storing said initial document data;
(b) providing a remote loading device for receiving said initial document data;
(c) wirelessly transmitting said initial document data into said remote loading device;
(d) updating said initial document data with an updated document data via said remote loading device; and
(e) wirelessly transmitting said updated document data to said data storage device to be stored therein.

2. The method according to claim 1, wherein said initial document data and said updated document data are transmitted via a data-transmitting unit.

3. The method according to claim 2, wherein said data-transmitting unit is a wireless module.

4. The method according to claim 3, wherein said wireless module is a wireless transmitting device.

5. The method according to claim 4, wherein said wireless transmitting device is one selected from a group consisting of an infrared-ray transmitting device, Bluetooth, 802.11X, Home RF, HIPER Lan, an optical transmitting device and a radio transmitting device.

6. The method according to claim 1, wherein said initial document data is said updated document data.

7. The method according to claim 1, wherein said step (b) further comprises a step of:
(b1) making a loading request of said initial document data via said remote loading device.

8. The method according to claim 1, wherein said step (b) further comprises a step of:
(b2)making a transmitting request of said initial document data via said data storage device.

9. The method according to claim 1, wherein said step (d) further comprises a step of:
(d1) temporarily storing one of said initial document data and said updated document data in a data storage unit of the remote loading device.

10. The method according to claim 1, wherein said step (d) further comprises a step of:
(d2) displaying one of said initial document data and said updated document data via a data-displaying unit.

11. The method according to claim 1, wherein said step (d) further comprises a step of:
(d3) transmitting one of said initial document data and said updated document data to one selected from a group consisting of a computer, a peripheral device, a PDA, a Web TV, a STB, and a play station via a data-transmitting unit.

12. The method according to claim 11, wherein said data-transmitting unit is a wireless transmitting device.

13. The method according to claim 1, wherein said step (c) further comprises a preceding step of:
compressing/uncompressing said initial document data via a data-transforming unit.

14. The method according to claim 1, wherein said step (c) further comprises a preceding step of:
coding/decoding said initial document data via a data-transforming unit.

15. The method according to claim 1, wherein said step (e) further comprises a preceding step of:
compressing/uncompressing said updated document data via a data-transforming unit.

16. The method according to claim 1, wherein said step (e) further comprises a preceding step of:
coding/decoding said updated document data via a data-transforming unit.

17. The method according claim 1, wherein said document data is one selected from a group consisting of a text file, a picture file, an audio file, a video file, and an image file.

18. A system for storing and updating an initial document data, comprising:
a data storage device having a data storage unit for storing said initial document data;
a remote loading device for receiving and updating said initial document data with an updated document data; and
a wireless module for transmitting said initial document data and said updated document data between said data storage device and said remote loading device.

19. The system according to claim 18, wherein said wireless module is a wireless transmitting device.

20. The system according to claim 19, wherein said wireless transmitting device is one selected from a group consisting of an infrared-ray transmitting device, Bluetooth, 802.11X, Home RF, HIPER Lan, an optical transmitting device and a radio transmitting device.

21. The system according to claim 18, wherein said storage unit is one selected from a group consisting of an EEPROM, a flash memory, a disk, a hard disk, a CD/VCD/DVD, a CF card, a SM card, a secure digital, a multi media card, a memory stick, a memory stick duo, a mask ROM, and a nonvolatile memory media.

22. The system according to claim 18, wherein said data storage device further comprises:
a data-transmitting unit for transmitting said initial document data stored in said data storage unit and receiving said updated document data transmitted from said remote loading device;
a data-compressing unit for compressing said initial document data and uncompressing said updated document data; and
a central processing unit for controlling an operating flow of said data storage unit, said data-compressing unit and said data-transmitting unit.

23. The system according to claim 18, wherein said data storage device further comprises:
a data-transmitting unit for transmitting said initial document data stored in said data storage unit and receiving said updated document data transmitted from said remote loading device;
a data-coding unit for coding said initial document data and decoding said updated document data; and
a central processing unit for controlling an operating flow of said data storage unit, said data-coding unit and said data-transmitting unit.

24. The system according to claim 18, wherein said remote loading device further comprises a temporary storage unit for temporarily storing one of said initial document data and said updated document data therein.

25. The system according to claim 24, wherein said temporary storage unit is one selected from a group consisting of an EEPROM, a flash memory, a disk, a hard disk, a CD/VCD/DVD, a CF card, a SM card, a secure digital, a multi media card, a memory stick, a memory stick duo, a mask ROM, and a nonvolatile memory media.

26. The system according to claim 24, wherein said remote loading device further comprises:
a data-transmitting unit for receiving said initial document data transmitted from said data storage device and transmitting said updated document data to said data storage device;
a data-compressing unit for compressing said updated document data and uncompressing said initial document data; and
a central processing unit for controlling an operating flow of said temporary storage unit, said data-compressing unit and said data-transmitting unit.

27. The system according to claim 24, wherein said remote loading device further comprises:
a data-transmitting unit for receiving said initial document data transmitted from said data storage device and transmitting said updated document data to said data storage device;
a data-coding unit for coding said updated document data and decoding said initial document data; and
a central processing unit for controlling an operating flow of said temporary storage unit, said data-coding unit and said data-transmitting unit.

28. The system according to claim 18, wherein said remote loading device further comprises a data-displaying unit for displaying one of said initial document data and said updated document data.

29. The system according to claim 18, wherein said initial document data and said updated document data are transmitted to one selected from a group consisting of a computer, a peripheral device, a PDA, a Web TV, a STB, and a play station via said remote loading device.

30. The system according claim 18, wherein said initial document data is one selected from a group consisting of a text file, a picture file, an audio file, a video file, and an image file.

31. The system according to claim 18, wherein said remote loading device loads said initial document data by means of making a loading request.

32. The system according to claim 18, wherein said data storage device transmits said initial document data by means of making a transmitting request.

33. A system for storing and updating an initial document data, comprising:
a data storage device having a data storage unit for storing said initial document data and a first wireless transceiver for transmitting said initial document data; and
a remote loading device having a processing unit for updating said initial document data with an updated document data and a remote wireless transceiver for receiving said initial document data and transmitting said updated document data to said data storage device.
